(19) United States
(12) Patent Application Publication
(10) Pub. No.: US 2021/0260645 A1
(43) Pub. Date: Aug. 26, 2021

(54) Press with Center Hole Hydraulic Cylinder

(71) Applicant: Ernest Rovinsky, Downey, CA (US)

(72) Inventor: Ernest Rovinsky, Downey, CA (US)

(21) Appl. No.: 17/180,758

(22) Filed: Feb. 20, 2021

Related U.S. Application Data
(60) Provisional application No. 62/979,745, filed on Feb. 21, 2020.

(51) Int. Cl. B21J 9/12; B21J 13/04

(52) U.S. Cl. CPC B21J 9/12; B21J 13/04

(57) ABSTRACT

A heavy-duty press is a mechanical machine used for compressing various parts and can be used for forging, molding, blanking, punching, deep drawing and many other applications. The force is generated by the use of hydraulic fluids based on Pascal's principle. The Press With Center Hole Hydraulic Cylinders simplifies the press design by using center hole hydraulic cylinders installed on the mobile platen with the press column inside the center hole. Center hole hydraulic cylinders being connected directly to the column eliminate the need of the third platen. A press with only two platens is cheaper and does not need large pits to be installed in. Also the design of the Press With Center Hole Hydraulic Cylinders use columns made of small section of hexagonal heat-treated steel bars arranged in an array forming a larger column of hexagonal shape. Columns made of small heat-treated bars are stronger, better connected to other press components and are much easier to fabricate and install.

### RELATED U.S. APPLICATION

Provisional application No. 62/979,745 filed on Feb. 20, 2020

### REFERENCE CITED

U.S. Patent Documents, U.S. CL. B30B.

| | | |
|---|---|---|
| 459,816 | Miller | September 1891 |
| 545,758 | Aiken | September 1895 |
| 1,580,894 | Hummel | April 1926 |
| 2,306,716 | Albers | December 1942 |
| 2,722,174 | Albers | November 1955 |

### BACKGROUND OF THE INVENTION

The present invention relates to hydraulic presses in general and more particularly to improvements of heavy-duty presses used for close dies forging. Large forged parts require very powerful and expensive hydraulic presses capable of generating enormous forces against the dies.

### DESCRIPTION OF THE PRIOR ART

A typical press is composed of three platen arranged one on top of the other and connected with vertical columns. The platens situated at the extremities have rigid connections to the columns while the platen situated in the middle can slide up and down alongside columns. The press has hydraulic cylinders situated between two consecutive platens while the forging dies are installed between the other two consecutive platens. The hydraulic cylinders operate at very high pressure generating the necessary force for forging. Energy is transmitted from the hydraulic cylinders to the dies thru platens and columns.

### SUMMARY OF THE INVENTION

The press frame needs to withstand very high values of cyclical forces applied to platens and columns and particularly felt in the area where columns are connected to platens. Accordingly, it is an object of the present invention to provide a press a frame that can withstand very high loads and which is easy to fabricate and install.

Another object of the invention is to provide hydraulic cylinders capable to generate the necessary force for forging.

The present invention describes a forging press with four columns, however the improvements can be applied successfully to a press with two columns.

The first improvement of the press consists in using center hole hydraulic cylinders and having the press columns installed thru the center hole. The improved press has only two platens, one on top of the other and connected with columns. The center hole hydraulic cylinders are installed on top of the sliding platen and at the other end are connected solid to the column end.

The advantages of using center hole hydraulic cylinders are:

The center hole hydraulic cylinders having the press column inside the center hole make it possible for the hydraulic actuator to be connected directly to the column end, eliminating the need for the third platen on the press. Eliminating the third platen reduces the press cost, platens being a very expensive part of a press. Also, there is no need for a large and deep pit where the third platen is usually installed.

The center hole hydraulic cylinders can be a double acting actuator eliminating the need for push back cylinders on the press.

The diameter of center hole hydraulic cylinder can be larger compared with hydraulic cylinders installed between two platens in the area limited by columns, resulting of a bigger piston area. Larger piston area reduce the need for very high pressure of the hydraulic fluid in order to generate the necessary force for forging

The second improvement of the press consists in replacing the large one-piece steel column with a column made of many small heat-treated bars arranged together in an array to form a larger column. All heat-treated bars have the same hexagonal cross section and are arranged together to form a wider hexagonal shape. Each small section steel bar is threaded at both ends in order to receive nuts. Perforated plates are installed at each column end to hold all the hexagonal bars together. One set of perforated plates connects the column lower end to the lower platen and another set of perforated plates connects the upper end of the column to the center hole hydraulic cylinders.

The advantages of the column made of an array of smaller bars are:

Small sections of steel bars of approx 2 inches can be heat-treated reaching allowable stress value of 120,000 psi, which is much higher in comparison with large sections of steel with allowable stress value of approx 40,000 psi.

Each heat-treated bar is connected to column end plates with a nut resulting in a very strong connection of the column with the platen due to the distribution of the load on the entire section of the column. In comparison a large solid round section column is connected to the platen with one single nut having the load distribution only on the circumference of the round section area.

The bars forming a column allow relative movement there between, giving the column some flexibility. A column that is flexible is less affected by bending moment and shear stress compared with equivalent solid round section columns.

A column made of an array of smaller bars is easier to fabricate, handle, transport, and install resulting in important cost reduction.

### BRIEF DESCRIPTION OF THE DRAWINGS

FIG. 1 represents a perspective view of the hydraulic press.

FIG. 2 represents a plan view of the hydraulic press.

FIG. 3 shows a section as seen in the direction of arrows from the line I-I of FIG. 2

FIG. 4 shows a section as seen in the direction of arrows from the line II-II of FIG. 3

FIG. 5 shows a detail view of the circle marked HI of FIG. 4.

### DETAILED DESCRIPTION OF THE INVENTION

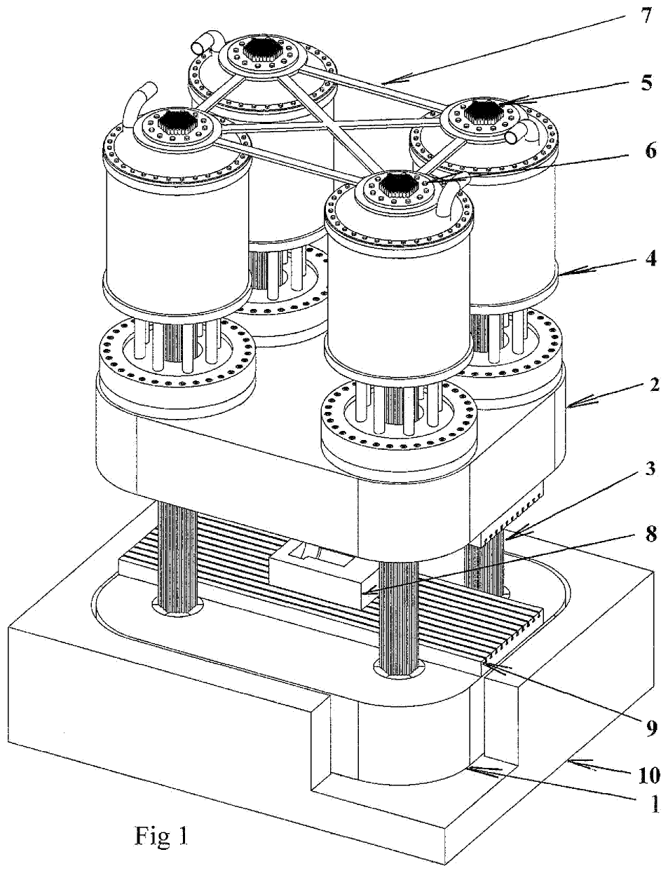

FIG. 1 is a perspective view of the press assembly comprising of Lower Platen 1, Upper Paten 2, and four Columns 3. The Center Hole Hydraulic Cylinder 4 is installed with the column inside the center hole and on top of the Upper Platen 2. Column 3 at both ends has Column End Plates 6 and Nuts 5. All four columns are connected at the upper end with a Frame 7 in order to improve the press rigidity. Between Lower Platen 1 and the Upper Platen 2 are installed Dies 8.

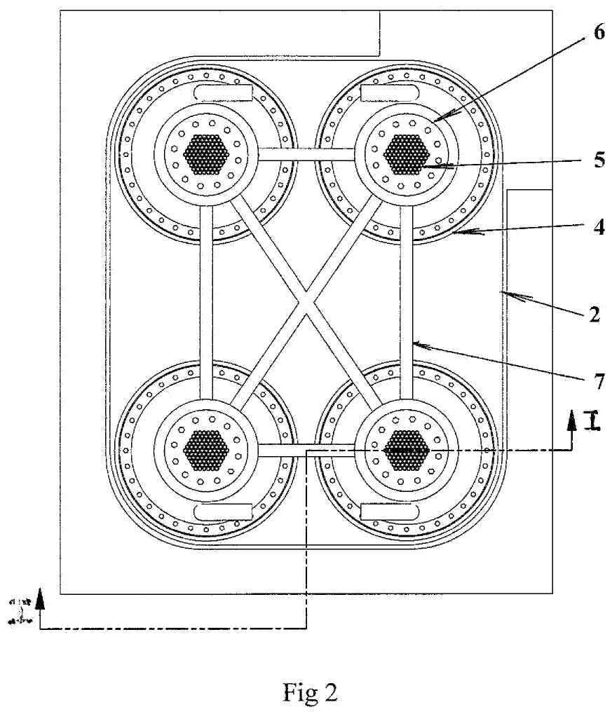

FIG. 2 represents the plan view of the press assembly showing the Upper Platen 2, Center Hole Hydraulic Cylinders 4, Column End Plate 6, and Nuts 5 connected to the end of heat-treated hexagonal bars.

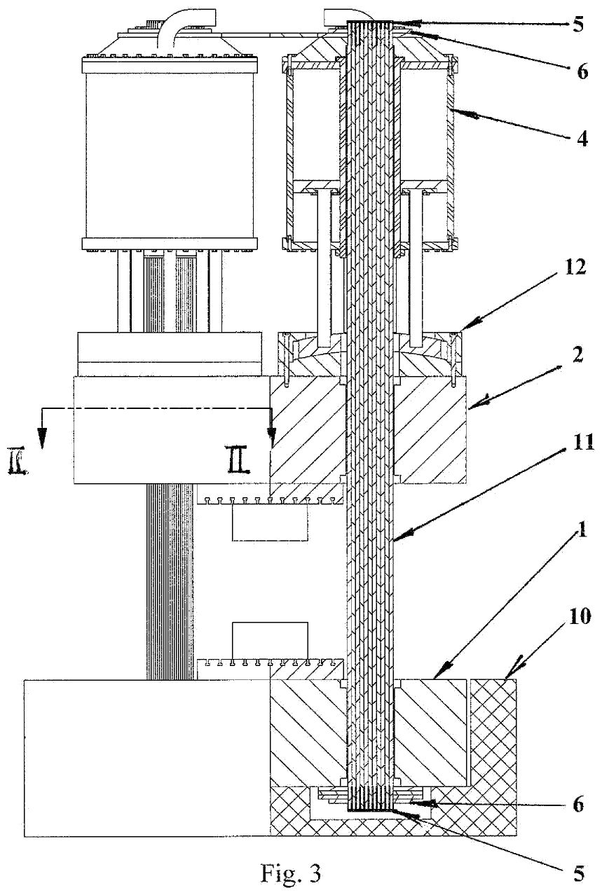

FIG. 3 represents a section view as seen in the direction of arrows from the line I-I of FIG. 2. The top of Lower Platen 1 is at the ground level and supports the lower die. Lower Platen 1 and Upper Platen 2 receives the columns thru openings. Columns 3 are made of Hexagonal Bars 11. Upper Platen 2 can slide up and down alongside columns having the Inserts 10 made of low friction material. Upper Platen 2 is also connected to the lower ring of the Center Hole Hydraulic Cylinder 4 by means of Spherical Connection 12, which allow for small misalignments of perpendicularity. Center Hole Hydraulic Cylinder 4 has the columns installed thru the center hole. All the hexagonal bars that form a column are machined round and threaded at both ends in order to go thru perforated Column End Plate 6 and receive Nuts 5.

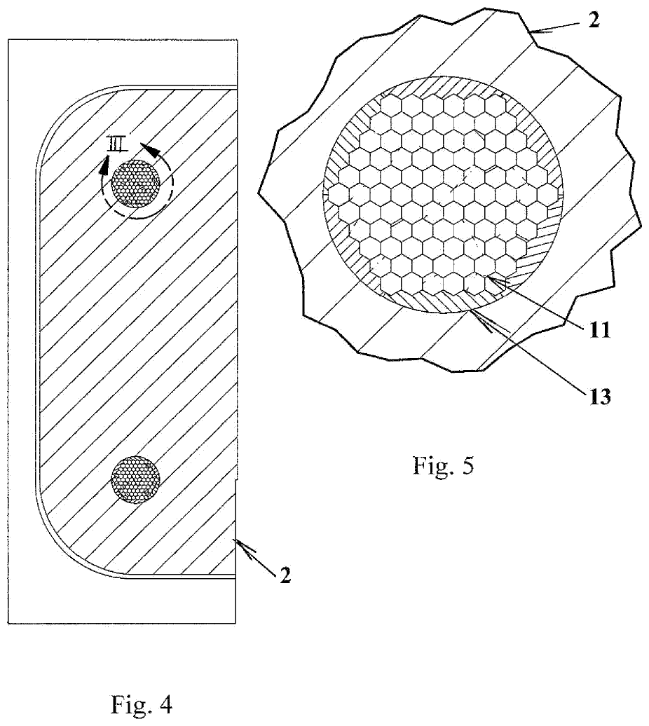

FIG. 4 represents a section view as seen in the direction of arrows from the line II of FIG. 3. Upper Platen 2 has openings to receive columns. Columns are made from smaller hexagonal bars, which are arranged to form a larger hexagonal section column.

FIG. 5 represents detail view II of FIG. 4. All heat-treated hexagonal bars are arranged to form a larger column of hexagonal shape. The hexagonal bars in this view are not hatched for clarity. The platen has round openings to receive columns and Inserts 13 make the transition to the hexagonal column profile. The sliding Platen 2 use low friction inserts to make contact with columns.

1. A heavy-duty press comprising of:
two platens, one on top of the other and having columns connecting them, one platen is connected rigidly to the lower end of columns while the second platen can slide alongside columns,
on top of the sliding platen are installed center hole hydraulic cylinders with the column inside the center hole and extending beyond the center hole hydraulic cylinders and being rigidly connected with the center hole hydraulic cylinders.

2. The press defined in claim 1 where:
the said columns for connecting the platens and hydraulic cylinders are made from multiple small sections of heat treated bars arranged in an array to form a larger and stronger column,
all the heat-treated bars have the same hexagonal profile and at both ends are machined to a round section and threaded in order to receive nuts,
all small heat treated bars that form a column are connected together at the ends by perforated plates with an array of holes to match the array of the heat-treated bars.
